(19) United States
(12) Patent Application Publication
(10) Pub. No.: US 2012/0085373 A1
(43) Pub. Date: Apr. 12, 2012

(54) WASHING SYSTEM

(75) Inventor: Epke Bosma, Schettens (NL)

(73) Assignee: DELAVAL HOLDING AB, Tumba (SE)

(21) Appl. No.: 13/376,863

(22) PCT Filed: Jun. 2, 2010
(86) PCT No.: PCT/EP2010/057713

§ 371 Date: Dec. 8, 2011

(30) Foreign Application Priority Data
Jun. 9, 2009 (SE) 0950426-7

(51) Int. Cl. A01J 7/02; B08B 3/04

(52) U.S. Cl. 134/108

(57) ABSTRACT

A washing system for washing equipment in a milking plant includes a closed flow circuit, a washing liquid source (14), a feeding part (7, 16) adapted to supply washing liquid from the washing liquid source (14) to a first portion (15) of the closed flow circuit and circulating part (10) adapted to circulate the washing liquid in the closed flow circuit during a washing process of the equipment (1, 2, 3, 8). The washing system further includes a heating part (7, 23-28) adapted to supply steam to at least a second vertical portion (19a) of the closed flow circuit during at least a part of the washing process for supplying heat energy to the circulating washing liquid. The second portion (19a) of the closed flow circuit is located at a distance from the first portion (15) of the closed flow circuit.

### THE BACKGROUND OF THE INVENTION AND PRIOR ART

The present invention relates to a washing system for washing equipment in a milking plant, wherein the washing system comprises a closed flow circuit, a washing liquid source, feeding means adapted to supply washing liquid from the washing liquid source to a first portion of the closed flow circuit and circulating means adapted to circulate the washing liquid in the closed flow circuit during a washing process of the equipment.

The milking equipment in a milking plant has to be washed with regular intervals. The milking equipment in a milking stall of a milking plant may include teat cups, milk conduits and a milk receiver. However, also other equipment in milking stalls, such as teat cleaning equipment, has to be washed with regular intervals. The teat cleaning equipment may include a teat cleaning cup, rollers, brushes, belts, sponges, cloths or the like which together with a cleaning liquid is adapted to perform a cleaning process of the teats of a milking animal before a milking process is started.

A conventional washing system may comprise a washing unit which supplies washing liquid with a desired composition and temperature to a first portion of the circuit. The first portion may be a washing trough. The washing liquid is circulated in the circuit during a predetermined period of time by a pump. Since the washing liquid is warmer than the components in the circuit, the washing liquid is successively cooled down during the washing process. A decreasing temperature of the washing liquid during the washing process is not good in view of washing effectiveness.

### SUMMARY OF THE INVENTION

The object of the present invention is to provide a washing system of the initially mentioned kind, where it is possible to maintain a desired temperature of the circulating washing liquid in a relatively simple manner during the whole washing process.

This object is achieved by the washing system initially defined, which is characterised in that the washing system comprises heating means adapted to supply steam to at least a second portion of the closed flow circuit during at least a part of the washing process for supplying heat energy to the circulating washing liquid, wherein the second portion of the closed flow circuit is located at a distance from the first portion of the closed flow circuit. The supplied steam may be saturated steam or superheated steam. Saturated steam is steam at its condensation temperature at a given pressure. Superheated steam is steam at a higher temperature than its condensation temperature at a given pressure. It is possible to store large amount of heat energy in steam which is supplied to the washing liquid during the washing process. The supplied steam heats the surrounding washing water in the circuit. At the same time, the steam is cooled down. When the steam has been cooled down to its condensation temperature, which is 100° C. at atmospheric pressure, it undergoes a phase transition and the steam condensates to liquid water. During this phase transition large amounts of heat energy is released, which heats the surrounding washing liquid. The condensed steam in the form of liquid water is mixed with the washing liquid and constitutes thereafter a part of the washing liquid. The steam used for heating the washing liquid may be generated during a relatively long period. It is thereby possible to generate the steam by means of a relatively simple electric heater with a low capacity.

It is possible to store and supply the generated steam to the circulating washing liquid in a relatively simple manner. Initially, the feeding means supplies washing liquid of a suitable temperature from the washing liquid source to the first portion of the closed flow circuit. During the following circulation of the washing water in the closed flow circuit, steam is supplied to the washing liquid at at least one second portion of the closed flow circuit located at a distance from the first portion. Such a steam supply at a suitably located second portion of the closed flow circuit makes it possible to maintain a desired temperature of the washing liquid during the whole washing process and increase the washing effectiveness.

According to an embodiment of the invention, the heating means comprises a steam source, a steam line, and a valve member arranged in the steam line, which is adapted to control the supply of steam to the washing liquid in the closed flow circuit. The steam source may be an insulated accumulator tank storing steam at a suitable temperature and pressure. The steam may be stored at a suitable overpressure in the accumulator tank. When the valve member is open, the steam flows from the accumulator tank, via the steam line, to the washing liquid in the closed flow circuit by means of said overpressure.

According to an embodiment of the invention, the heating means may comprise a control unit adapted to control the valve member. The control unit may be a computer or the like provided with a suitable software for this purpose. Alternatively, the valve member may be manually controlled by an operator. The heating means may be adapted to supply an amount of steam to the second portion of the closed circuit such that the washing liquid is heated to maintain a desired temperature. The steam may be supplied substantially continuously during the washing process, Alternatively, the steam may be supplied at one or several occasions during the washing process. The heating means may be adapted to heat the washing liquid to a temperature which varies in a predetermined manner during the washing process. Preferably, the washing liquid has relative low temperature during an initial part of the washing process in order to loosen deposits on the surfaces of the equipment and a higher temperature during an ending part of the washing process in order to kill bacteria and micro-organisms in the equipment. The temperature of the washing liquid may vary in accordance with a predetermined temperature profile during the washing process.

According to a preferred embodiment of the invention, the steam is supplied to a second portion of the closed flow circuit in which the washing liquid forms a substantially vertical water column. Since the steam has a lower density than the washing liquid, the supplied steam will rise in the washing liquid. In order to achieve an effective heating of the washing liquid, it is suitable that the steam condensates in a position inside the washing liquid volume and not in a position at, for example, an upper wall surface of a conduit forming the closed flow circuit. The steam may be supplied in a second portion in the form of a vertical conduit of the closed flow circuit. The steam may be supplied to a second portion of the closed flow circuit in which the washing liquid flows upwards in the vertical water column. Thereby, the supplied steam does not obstruct the flow of the washing liquid in the closed flow circuit.

According to a preferred embodiment of the invention, the closed circuit comprises an inlet passage adapted to convey washing liquid to said equipment and a return passage adapted to recirculate washing liquid from the equipment to the inlet passage. Such passages, which may comprise conduits, form a closed flow circuit for the washing liquid. The closed flow circuit may comprise drain means adapted to draw off washing liquid from the circuit when a washing process has been finished. The drain means may be arranged in a lower part of the closed flow circuit. The drain means may comprise a control valve and a drain line. The control unit may open the control valve when the washing process has been finished such that the used washing liquid is drawn off from the closed flow circuit.

According to a further embodiment of the invention, the circulating means comprises a pump. Such a pump may be an existing pump in the equipment or a pump only used for this purpose. It is also possible to use other kinds of circulating means than pumps. The washing liquid may be adapted to be circulated in the closed flow circuit during a predetermined period of time during a washing process of the equipment. The washing liquid may, for example, be circulated in the closed flow circuit during a period of time of about six minutes. Preferably, said equipment is provided with a flow passage constituting a part of the closed circuit for the washing liquid. The equipment may comprise flow passages for other liquids such as milk and cleaning liquid which have to be washed by the washing liquid. The equipment may be a teat cleaning equipment adapted to perform a cleaning process of the teats of a milking animal. The teat cleaning equipment may comprise a teat cleaning member in the form of a teat cleaning cup, rollers, brushes, belts, sponges, cloths or the like which together with a cleaning liquid cleans the teats. Such a teat cleaning equipment may comprise conduits and a container for conveying away used cleaning liquid.

According to a preferred embodiment of the invention, said equipment is milking equipment in a milking stall. Especially, the surfaces of milking equipment which are in contact with milk have to be washed carefully. Said milking equipment may comprise teat cups. It is important that the teat cups are clean such that dirt and bacteria will not be mixed into the milk. Said milking equipment may also comprise at least one milk conduit and a milk receiver connected to the teat cups. The milk equipment in a milking stall may comprise milk conduits adapted to convey milk from the respective teat cups to a milk receiver.

The milk equipment may also comprise a milk conduit with a milk pump adapted to circulate milk from the milk receiver to a main milk tank for several milking stalls in the milking plant. During a washing process, the washing liquid may be circulated through a closed flow circuit comprising these milk passages.

According to a preferred embodiment of the invention, the washing system may comprise connecting members adapted to be connected to a respective teat cup during the washing process, wherein the connecting members comprise a portion of the inlet passage conveying washing liquid to the teat cups. The washing liquid is here supplied to the teat cups by means of the flow passages in the connecting members. The connecting members may be rod-like members which are movably arranged between a retracted position and a washing position in which they protrude into an inner space of the teat cups.

### BRIEF DESCRIPTION OF THE DRAWINGS

The present invention is now to be explained more closely by means of a preferred embodiment which is disclosed as an example and with reference to the attached drawing.

FIG. 1 shows an embodiment of a washing system according to the invention.

### BRIEF DESCRIPTION OF A PREFERRED EMBODIMENT OF THE INVENTION

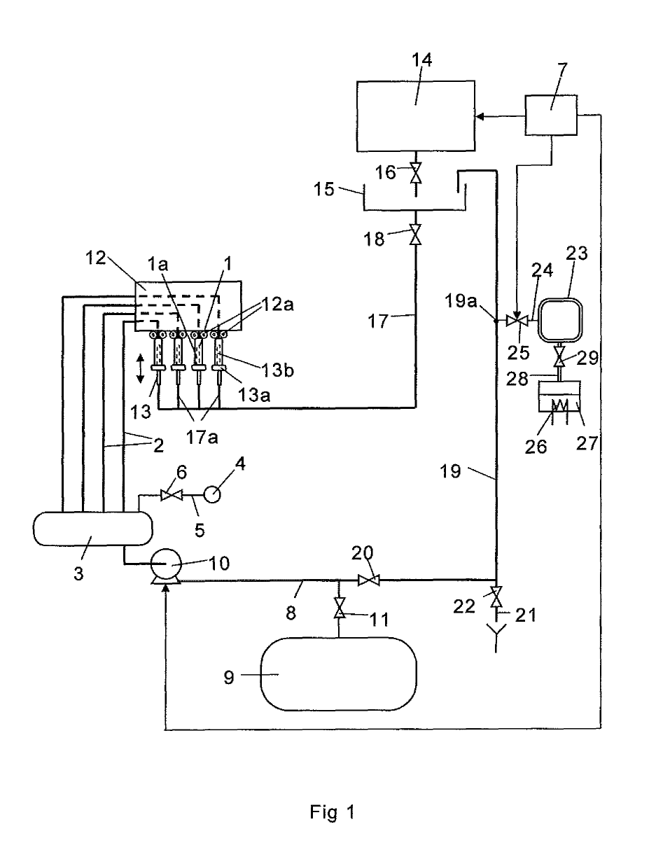

FIG. 1 shows a washing system for washing milking equipment in a milking stall of a milking plant. The milking plant comprises a plurality of milking stalls. The milking equipment in each milking stall comprises four teat cups 1 each provided with milk conduit 2. The teat cup 1 comprises a recess 1 a adapted to receive a teat during a milking process. The milk conduits 2 are adapted to convey milk from the teat cups 1 to a milk receiver 3 of the milking equipment. A vacuum source 4 is connectable to the milk receiver 3 by means of a vacuum line 5 and a control valve 6. A control unit 7 is adapted to control the control valves 6. Furthermore, the milking equipment comprises a milk conduit 8 adapted to convey milk from the milk receiver 3 to a main milk tank 9 for several milking stalls of the milking plant. A pump 10 is arranged in the milk conduit 8. A control valve 11 is adapted to control the milk flow to the main tank 9.

When a milking process is to be performed, a milking robot or an operator attaches the teat cups 1 to the teats of a cow in the milking stall. The control unit 7 opens the control valve 6 such that a vacuum pressure is applied to the milk receiver 3 and the milk conduits 2. Thereby, milk is sucked from the teat cups 1, via the milk conduits 2, to the milk receiver 3. The control unit 7 closes the control valve 6 when the milking process has been finished and activates the pump 10 such that it pumps the milk from the milk receiver 3, via the milk conduit 8, to the main milk tank 9. The teat cups 1 are removed from the teats and retracted to a parking position in a teat cup storing device 12. The teat cup storing device 12 comprises rollers 12a adapted to define a respective parking position of the teat cups 1. The teat cups are shown in the parked position in FIG. 1. The teat cups 1 are each provided with an opening to the recess 1a which is directed downwards in the parked position.

The washing system comprises a washing unit 14 adapted to supply washing liquid of a desired composition and temperature to a washing trough 15 via a control valve 16. An inlet conduit 17 is adapted to receive washing liquid from the washing trough 15 via a control valve 18. The inlet conduit 17 comprises four branched portions 17a adapted to convey washing liquid to a respective connecting member 13. The connecting members 13 are movably arranged between a retracted position and a washing position. Each connecting member 13 comprises a support portion 13a and a projecting rod-like portion 13b adapted to protrude into the recess 1a of a teat cup 1 when it is in the washing position. FIG. 1 shows the teat cups 1 in the parked position in the teat cup storing device 12 and the connecting members 13 when they have been moved to the washing position. The branched portions 17a of the inlet conduit 17 include one or several openings in the rod-like portions 13b of the connecting members 13 from which the washing liquid is supplied to the recesses 1a of the teat cups 1. The washing liquid is adapted to be supplied with a pressure to the teat cups 1 such that it flows from the recess 1a of the teat cup 1 into the milk conduits 2 and to the milk receiver 3. Furthermore, the washing system comprises a return conduit 19 adapted to return washing liquid from the milk conduit 8 to the washing trough 15 during a washing process. A control valve 20 is adapted to control the flow of washing liquid from the milk conduit 8 to the return conduit 19. The return conduit 19 comprises a drain line 21 provided with a control valve 22.

The washing system comprises a steam accumulator 23, a steam passage 24 and a control valve 25 adapted to control the supply of steam from the steam accumulator 23 to a portion 19a of the return conduit 19. The control unit 7 is adapted to control the control valve 25. The steam accumulator 23 may be an insulated pressure tank containing steam at an overpressure. A boiler 27 is adapted to heat liquid water such that it is evaporated to steam by means of a heating device which in this case is an electric heating device 26. Alternatively, a gas, an oil, a firewood heating device etc. may be used. The steam is supplied to the container 23 via a steam line 28 and a control valve 29.

When a washing process is to be performed, the connecting members 13 are moved from the retracted position to the washing position. The control unit 7 controls the washing unit 14 such that it supplies washing liquid with a desired temperature and composition to the washing trough 15. The temperature of the washing liquid may be below 60° C. The washing liquid may be water or water with a detergent. The control unit 7 opens the control valve 18 such that washing liquid flows from the washing trough 15 to the inlet conduit 17 and to its branched portions 17a. Then, the washing liquid flows from the branched portions 17a into the recesses la of teat cups 1 via the projecting members 13b of the connecting members 13. The washing liquid is supplied with a pressure such that it flows up in the milk conduits 2 and to the milk receiver 3. The control unit 7 starts the pump 10 such that it circulates washing liquid from the milk receiver 3 to the milk conduit 8. During the washing process, the control unit 7 has set the control valve 11 in a closed position and the control valve 20 in an open position such that the washing liquid flows from the milk conduit 8 to the return conduit 19. The return conduit 19 conveys the washing liquid back to the washing trough 15. Consequently, the washing liquid is circulated in a closed circuit during the washing process. When a desired quantity of washing liquid has been supplied to the flow circuit, the control unit 7 closes the control valve 16 such that no more washing liquid is supplied to the washing trough 15. The pump 10, which in this case is an existing milk pump in the milking equipment, circulates the washing liquid through the closed circuit. The washing liquid has a relatively low temperature during an initial part of the washing liquid. Thereby, the washing liquid has during this part of the washing process a good ability to loosen milk deposits from the inner surfaces of the teat cups 1, the milk conduits 2, the milk receiver 3 and the milk conduit 8.

During at least one occasion of the washing process, the control unit 7 opens the control valve 25 such that steam is injected into the portion 19a of the return conduit 19. The steam may be superheated steam having a temperature of about 160° C. The injected steam heats the surrounding washing liquid. At the same time, the steam is cooled down. When the steam has been cooled down to a temperature of about 100° C., It undergoes a phase transition and condensates to liquid water. During this phase transition large amounts of heat energy is released which heat the washing liquid in the portion 19a of the return conduit 19. In this case, the steam is injected in a portion 19a of the return conduit 19, in which the washing liquid forms a vertical water column. The washing water flows upwards in this part 19a of the return conduit 19. Due to the lower density of the steam compared to the washing liquid, the injected steam flows upwards with a higher velocity than the washing liquid until it condensates. Thus, the supplied steam does not obstruct the flow of the washing liquid in the closed flow circuit.

During the washing process, washing liquid is circulated in the closed circuit during a predetermined period of time. In order to perform an effective washing process of the milking equipment, it is suitable that the temperature of the washing liquid is increased to a relatively high temperature during a part of the washing process such that bacteria and micro-organisms in the milking equipment are killed. When the washing liquid has to be heated, the control unit 7 open the control valve 25 such that it supplies a desired amount of steam to the washing liquid in the portion 19a of return conduit 19. The steam may be supplied continuously or at certain parts of the washing process such that the temperature of the washing liquid follows a predetermined temperature profile. When the washing process of the milking equipment is finished, the control unit 7 opens the control valves 22 such the washing liquid is discharged from the circuit via the drain line 21. The connecting members 13 are moved to the retracted position. The milking equipment has now been washed and the teat cups 1 are ready to be attached to a cow in the milking stall.

The invention is not restricted to the described embodiment but may be varied freely within the scope of the claims. It is possible to supply steam to the washing liquid at several places in the second portion of the closed flow circuit. It is also possible to supply steam to the second portion of the closed flow circuit in order to maintain a substantially constant temperature of the washing liquid during at least a part of the washing process.

1-16. (canceled)

17. A washing system for washing milking equipment in a milking plant, comprising:
a closed flow circuit for circulating a washing liquid through milking equipment (1, 2, 3, 8) of a milking plant during a washing process of the milking equipment, the closed flow circuit comprising a first portion (15) and a second portion (19a), the second portion (19a) located at a downstream distance from the first portion (15);
a washing liquid source (14);
a feeding part (16) arranged to supply the washing liquid from the washing liquid source (14) to the first portion (15) of the closed flow circuit;
a circulating unit (10) connected to circulate the washing liquid in the closed flow circuit, including both the first and second portions, during the washing process of the milking equipment; and
a heating unit (23-28) connected to the second portion (19a) of the closed flow circuit, the heating unit to supply steam into the second portion (19a) during at least a part of the washing process, the supplied steam for supplying heat energy to the washing liquid circulating in the closed flow circuit.

18. A washing system according to claim 17, wherein the heating unit is connected to the second portion (19a) at a location where, during the washing process, the washing liquid flows upwards in a vertical water column so that the steam is supplied into the second portion where the washing liquid flows upwards in the vertical water column.

19. A washing system according to claim 17, further comprising:
a control unit (7), wherein the control unit is operative to control, during the washing process, the feeding part (16), the circulating unit (10), and the heating unit (23) supplying steam into the second portion (19a).

20. A washing system according to claim 19, wherein the heating unit comprises a steam source (23), a steam line (24) and a valve (25) arranged in the steam line (24), the control unit (7) operative to control the valve (25) to control the supply of steam to the second portion (19a) and thereby to the washing liquid circulating in the closed flow circuit.

21. A washing system according to claim 17, wherein the heating unit comprises i) a valve (25) connected to control the supply of steam to the second portion (19a) and ii) a control unit (7) operative to control the valve (25) to control the supply of steam to the second portion (19a) and thereby to the washing liquid circulating in the closed flow circuit.

22. A washing system according to claim 17, further comprising:
a control unit (7), wherein the control unit is operative to control, during the washing process, an amount of steam provided by the heating unit (23-28) into the second portion (19a) such that the washing liquid is heated to a predetermined temperature.

23. A washing system according to claim 22, the control unit (7) is adapted to control the amount of steam to heat the washing liquid to a temperature which varies in a predetermined manner during the washing process.

24. A washing system according to claim 17, wherein the closed flow circuit further comprises an inlet passage (17) arranged to convey the washing liquid to the milking equipment equipment (1, 2, 3, 8) and a return passage (19) arranged to recirculate the washing liquid from the equipment (1, 2, 3, 8) to the inlet passage (17), and the second portion is located within the return passage.

25. A washing system according to claim 17, wherein the closed flow circuit further comprises drain (21, 22) arranged to draw off the washing liquid from the closed flow circuit when the washing process has been finished.

26. A washing system according to claim 17, wherein the circulating unit comprises a pump (10).

27. A washing system according to claim 19, wherein the control unit (7) is adapted to circulate washing liquid in the closed flow circuit during a predetermined period of time during the washing process of the milking equipment (1, 2, 3, 8).

28. A washing system according to claim 17, wherein a flow passage of the milking equipment (1, 2, 3, 8) comprises a portion of the closed flow circuit for the washing liquid.

29. A washing system according to claim 28, wherein the milking equipment comprises teat cups (1).

30. A washing system according to claim 29, wherein the milking equipment, forming the portion of the closed flow circuit, further comprises at least one milk conduit (2, 8) and a milk receiver (3) connected to the teat cups (1).

31. A washing system according to claim 29, wherein,
the closed flow circuit further comprise connecting members (13) adapted to be connected respectively to the teat cups (1),
the connecting members (13) each comprise a portion (13b) conveying the washing liquid to the teat cups (1), and
the connecting members (13) are movably arranged between a retracted position and a washing position where, during the washing process, the washing liquid flows into the teat cups (1).

32. A washing system according to claim 17, wherein,
the milking equipment comprises teat cups (1),
the closed flow circuit further comprises connecting members (13) adapted to be connected respectively to the teat cups (1), and
the connecting members (13) are movably arranged between a retracted position and a washing position where, during the washing process, the washing liquid flows into the teat cups (1).

33. A washing system according to claim 18, wherein, the heating unit (23-28) is controlled to supply steam to the substantially vertical water column in the second portion (19a), the supplied steam steam flowing upwards in the second portion (19a) with a higher velocity than a velocity of the washing liquid flowing upwards in the second portion (19a).

34. A washing system according to claim 17, wherein, the second portion (19a) is a vertical portion and the washing liquid forms a substantially vertical water column in the second portion where the heating unit supplies steam to the washing liquid circulating in the second portion.

35. A washing system for washing milking equipment in a milking plant, comprising:
a closed flow circuit for circulating a washing liquid through teat cups (1) of a milking plant during a washing process of the milking equipment, the closed flow circuit comprising a first portion (15) upstream the teat cups and a second portion (19a) at a distance downstream from the teat cups;
a circulating unit (10) connected to circulate the washing liquid in the closed flow circuit, including the teats cups (1) and the first and second portions (15, 19a), during the washing process of the milking equipment; and
a heating unit (23-28) connected to the second portion (19a) of the closed flow circuit and controlled to supply steam into the second portion (19a) during at least a part of the washing process while circulating the washing liquid through the first and second portions, the supplied steam supplying heat energy to the washing liquid circulating in the closed flow circuit.
